(19) United States
(12) Patent Application Publication
(10) Pub. No.: US 2024/0329349 A1
(43) Pub. Date: Oct. 3, 2024

(54) OUTSIDE FIBER TO INSIDE FIBER MODULAR INTERCONNECT SYSTEM

(71) Applicant: viaPhoton, Inc., Aurora, IL (US)

(72) Inventors: Nathan Eric BENTON, Dallas, TX (US); Walter Mark HENDRIX, Dallas, TX (US); Jeffrey Earl JONES, Sr., Stewartstown, PA (US); Mark James SMRHA, Chicago, IL (US); Joshua Wayne TOD, Chicago, IL (US); Wade James WOMACK, Allen, TX (US)

(21) Appl. No.: 18/620,955

(22) Filed: Mar. 28, 2024

Related U.S. Application Data
(60) Provisional application No. 63/455,549, filed on Mar. 29, 2023.

(51) Int. Cl. G02B 6/44

(52) U.S. Cl. CPC G02B 6/4454; G02B 6/443; G02B 6/4452

(57) ABSTRACT

A splice cabinet includes a plurality of color-coded panels and a plurality of color-coded runways corresponding to the plurality of color-coded panels. A plurality of color-coded sleeves corresponding to the plurality of color-coded channels and comprising a plurality of optical fibers. The rack, the plurality of color-coded panels, the plurality of color-coded runways, and the plurality of color-coded sleeves are installed into a cabinet.

### CROSS-REFERENCE TO RELATED APPLICATIONS

This application claims the benefit of U.S. Provisional Application 63/455,549, entitled “Outside Fiber to Inside Fiber Modular Interconnect System” and filed Mar. 29, 2023, which is incorporated by reference herein.

### BACKGROUND

Modern digital communication networks facilitate the rapid exchange of vast quantities of data, supporting a wide array of services from cloud computing to streaming media. As digital technologies evolve, and the volume of data traffic increases, the infrastructure that supports these exchanges, particularly the connections between data center campuses, must grow to manage the demands of increased data throughput, including greater scalability, faster deployment capabilities, and improved efficiency. As the volume of data exchanged and the reliance on cloud-based services continue to grow, so does the need for efficient, dependable, and scalable cabling systems.

### SUMMARY

An aspect of the invention is directed to an apparatus. The apparatus includes a plurality of color-coded panels. The apparatus also includes a plurality of color-coded runways corresponding to the plurality of color-coded panels. The apparatus further includes a plurality of color-coded sleeves corresponding to the plurality of color-coded channels and comprising a plurality of optical fibers.

Another aspect of the invention is to a method of installing optical fibers within a splice cabinet. The method includes receiving a set of outside premises (OSP) fibers, and a set of inside premises (ISP) fibers at a splice cabinet. The method also includes selecting a color-coded panel from a plurality of color-coded panels within the splice cabinet based on the desired connectivity. The method additionally includes inserting optical fibers from the OSP fibers and the ISP fibers into color-coded sleeves that correspond to the chosen color-coded panel. The method further includes choosing a corresponding color-coded runway that aligns with the selected color-coded panel and routing the color-coded sleeves through the corresponding color-coded runway to the color-coded panel.

Another aspect of the invention is directed to a splice cabinet. The splice cabinet includes a plurality of color-coded panels and a plurality of color-coded runways corresponding to the plurality of color-coded panels. The splice cabinet also includes a plurality of color-coded sleeves corresponding to the plurality of color-coded channels and comprising a plurality of optical fibers. The splice cabinet also includes a cabinet into which the rack, a plurality of color-coded panels, the plurality of color-coded runways, and the plurality of color-coded sleeves are installed.

Other aspects of the invention will be apparent from the following description and the appended claims.

### BRIEF DESCRIPTION OF DRAWINGS

FIG. 1 shows a diagram of a multi-tenant data center in accordance with one or more embodiments of the invention.

FIG. 2 shows a splice cabinet in accordance with one or more embodiments of the invention.

FIG. 3 shows a flowchart for a method of installing optical fibers within a splice cabinet in accordance with one or more embodiments of the invention.

Like elements in the various figures are denoted by like reference numerals for consistency.

### DETAILED DESCRIPTION

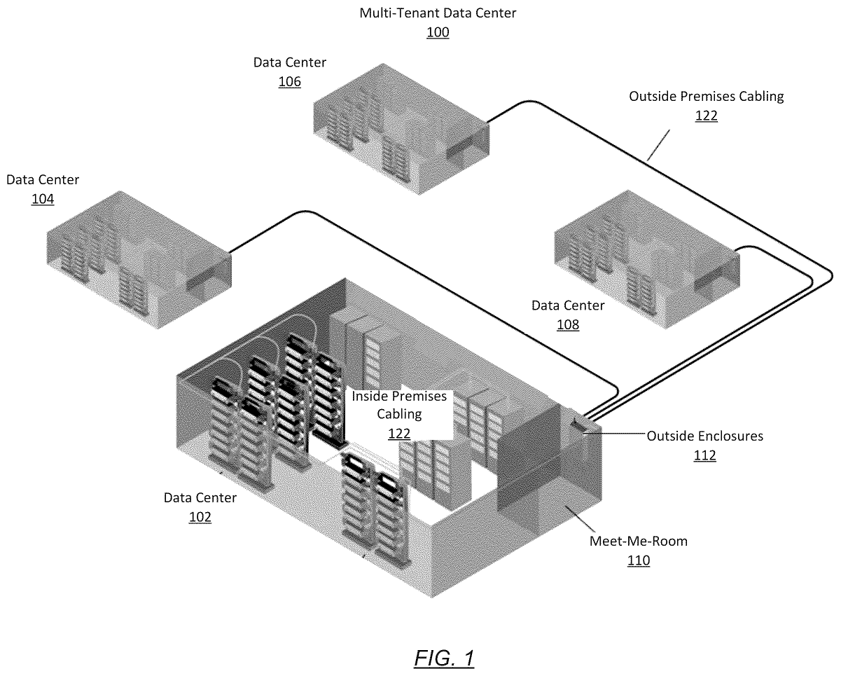

Turning to FIG. 1, a diagram of a multi-tenant data center is shown according to illustrative embodiments. Multi-tenant data center (100) illustrates the structural layout and interconnection of major components.

Multi-tenant data center (100) may comprise one or more separate data center (DC) buildings. As shown, multi-tenant data center (100) includes DC (102), DC (104), DC (106), and DC (108). DC (102), DC (104), DC (106), and DC (108) are individual data center buildings within the multi-tenant data center (100), each containing local equipment and resources interconnected via inside premises (ISP) cabling (120).

Each of DC (102), DC (104), DC (106), and DC (108) may function independently but are interconnected through outside premises (OSP) cabling (122). OSP cabling (122) is the cabling system that interconnects the different buildings of DC (102), DC (104), DC (106), and DC (108).

As illustrated, OSP cabling (122) enters DC (102) at a meet-me-room (110) through outside enclosures (112). Meet-me room (110) is a physical space within a data center is where the interconnection between different service providers occurs. Meet-me room (110) provides a shared area that allows for the physical connection between the data center's internal network and external telecommunications and service provider services. The meet-me room may house patch panels, switches, and other networking equipment that facilitates the interconnection and exchange of data between ISP cabling (120) and OSP cabling (122).

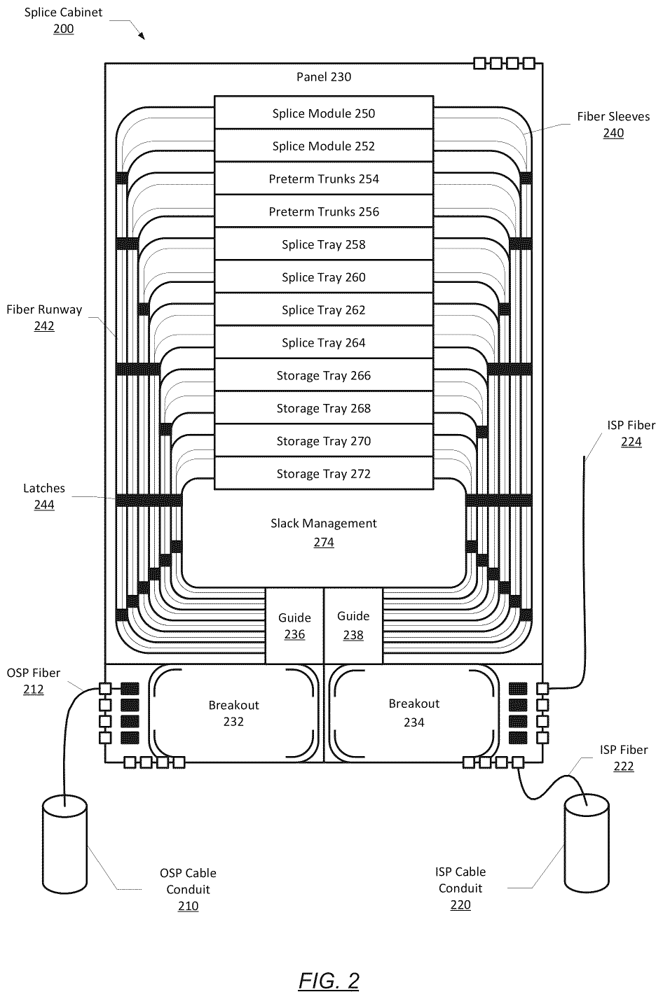

Referring now to FIG. 2, a splice cabinet is shown according to illustrative embodiments. The splice cabinet (200) houses the various components for fiber optic cable management within a data center environment, such as in the meet-me-room (110) of FIG. 1.

The splice cabinet (200) may be used in the interconnection between Outside Plant (OSP) and Inside Plant (ISP) fiber cables, and facilitates various fiber applications such as presentation, splicing, fiber slack storage, and interconnection. The splice cabinet (200) is a housing, serving as a central hub where OSP and ISP fiber cables converge, spliced, and managed.

The splice cabinet (200) is designed to organize, protect, and provide access for maintenance or modifications of optical splices between OSP fiber (212) and ISP fiber (222). The splice cabinet (200) includes rack features for the organization of fiber groups, to aid in the preparation of fibers, such as provisions for stripping, binding, and applying color-coded protective sleeves. Fiber jumpers may be provided to link to switching equipment.

OSP cable (210) is an example of OSP cabling (122) of FIG. 1: OSP cable (210) carries OSP fiber (212), which are the fibers that come into the splice cabinet from the external environment, such as from other data centers, buildings, or external networks.

ISP cable (220) is an example of ISP cabling (120) of FIG. 1. Similar to the OSP cable (210), ISP cable (220) protects the ISP fiber (222) when entering the splice cabinet (200), but is designed for the interior environment of a data center.

Both the OSP cable (210) and ISP cable (220) may utilize various quantities of fibers, including configurations of 2*1728 fibers, 1*3456 fibers, and 1*6912 fibers, with organized conduit paths to facilitate large-scale operations.

Splice cabinet (200) includes panel (230). The panel (230) provides a fixed point where cables can be spliced and managed, which may include coupling, splitting, or routing of fiber optic cables to various destinations. The panel (230) may be Slide-out splice panels having one or more removable modules, allowing for easier access during maintenance and/or system reconfiguration. These panels connect via fiber jumpers to the switching equipment, facilitating the routing of signals through the network.

Each of the panel (230) are color-coded panels. The color coding serves as an interface for fiber management, allowing for the organization and identification of different fiber connections. The color-coded panels may correspond to specific fiber pathways.

At breakout(s) (232) and (234), individual fibers are separated from a multi-fiber cable for individual management, splicing, and/or routing. Groups of OSP fiber (212) and ISP fiber (222, 224) are stripped out and bundled into color-coded fiber sleeves (240).

Fiber sleeve(s) (240) are protective coverings placed over fibers to organize and protect groups of fibers. The fiber sleeve(s) (240) may contain a strength member, to provide rigidity and prevent excessive bending. The fiber sleeve(s) are then routed into fiber runway(s) (242) at guide (236) and guide (238).

Fiber runway(s) (242) function as pathways for fiber cables within the cabinet. The fiber runway(s) (242) provide guided paths for specific groups of fibers to corresponding splice tray(s) or modules, allowing for neat routing while preventing unnecessary stress or bending of the fibers. The runway ensures that fibers maintain an appropriate bend radius to prevent signal loss or damage. The fiber runway(s) (242) are color-coded, utilizing a consistent scheme with the panel (230) and the fiber sleeve(s) (240).

Latches 244 secure the fiber sleeve(s) (240) within the fiber runway(s) (242). The latches 244 may be color-coded, utilizing a consistent scheme with the panel (230), fiber sleeve(s) (240), and fiber runway(s) (242).

The cabinet includes a series of splice module(s) (250, 252). The splice module(s) (250, 252) are compartments within the cabinet, associated with one of panels (230), holding protecting and organizing the fiber splices. Each module may be dedicated to a specific splice type or a particular set of connections. The splice module(s) (250, 252) may have a modular configuration that facilitates adding and/or removing of modules to support scalability and maintenance.

Preterm trunk(s) (254, 256) are compartments within the cabinet, associated with one of panels (230). Preterm trunk(s) (254, 256) may house pre-terminated fiber trunks having connectors already installed on both ends of the OSP fiber (212) and ISP fiber (222), allowing for the quick connection of cables.

Splice tray(s) (258, 260, 262, and 264) are compartments within the cabinet, associated with one of panels (230). The splice tray(s) (258, 260, 262, and 264) trays hold individual fiber splices and keep the splices organized. Each tray is modular, allowing for customization based on the number of splices and the type of fiber application.

Storage tray(s) (266, 268, 270, and 272) are compartments within the cabinet, associated with one of panels (230). The storage tray(s) (266, 268, 270, and 272) provide dedicated spaces for storing excess lengths of fibers to be used in future splices or rerouting for future network changes. The storage tray(s) (266, 268, 270, and 272) allow for fiber length management, ensuring that enough slack is available for maintenance without causing undue stress on the fibers.

Slack management 274 are compartments within the cabinet, associated with one of panels (230). Slack management 274 manages the excess fiber cable slack, to prevent strain on fibers and to maintain cable organization. Slack management 274 may comprise rack rails, e.g., 19-inch rack rails, to house surplus cable lengths.

The splice cabinet (200) features components that are color-coded to indicate distinct channels and/or containment structures, a common color-coding scheme across various components such as runways, fiber sleeve(s), panels, and channels, serving multiple functional purposes to streamline operations within the data center.

For example, a common color scheme employed throughout the splice tray may promote error reduction among technicians working within the data center. Each color may correspond to a specific type or category of cables, which is particularly important when managing the myriad of connections between OSP fiber (212) and ISP fiber (222). The clear distinction offered by colors mitigates the risks of accidental misconnections or disconnections that could lead to network outages.

A common color scheme may accelerate troubleshooting and repairs. In the event of a system failure or maintenance requirement, technicians can quickly identify the relevant cables and pathways based on color. This visual cueing may be helpful when navigating the dense and complex configurations. Faster identification means quicker repairs, which aides in maintaining high network availability.

The color-coordinated environment depicted in the figures may also contribute to scalability. As data centers expand, new cables and connections need to integrate with the existing infrastructure. The established color scheme simplifies this process, making evident where and how new components fit into the system. For example, the splice cabinet (200) may include multiple trays and panels that can accommodate expansion, with color coding to facilitate the integration of additional fibers and connections.

While FIG. 2 shows a configuration of components, other configurations may be used without departing from the scope of the invention. For example, various components may be combined to create a single component. As another example, the functionality performed by a single component may be performed by two or more components.

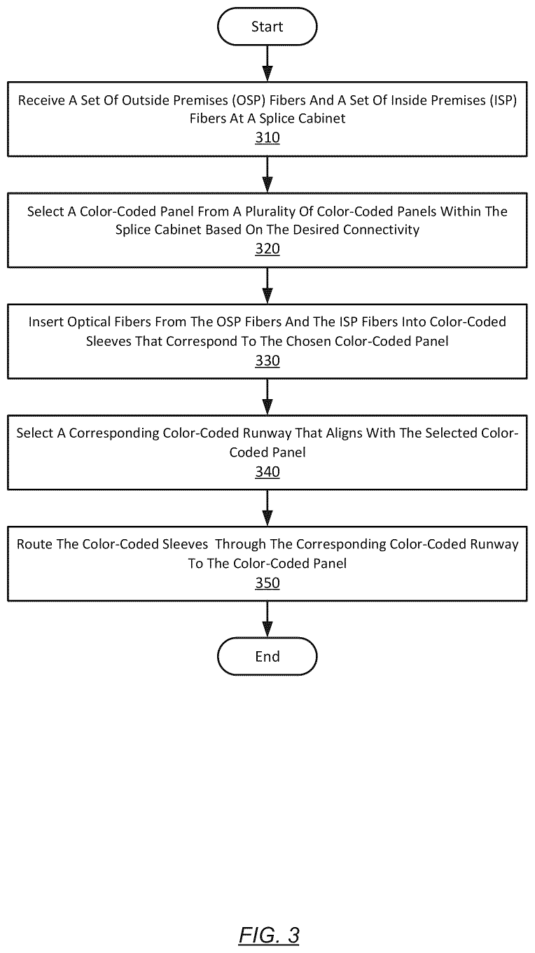

Turning to FIG. 3, a flowchart for a method of installing optical fibers within a splice cabinet is shown according to illustrative embodiments. The method of FIG. 3 can be performed using the splice cabinet (200) of FIG. 2.

At step 310, a set of outside premises (OSP) fibers and a set of inside premises (ISP) fibers are received at a splice cabinet.

At step 320, a color-coded panel selected from a plurality of color-coded panels within the splice cabinet based on the desired connectivity.

In some embodiments, selecting a color-coded panel may include referencing a labeling system that indicates a connectivity associated with each color-coded panel.

In some embodiments, the color-coded panels include ports that align with the color-coded runways to facilitate a structured routing of the optical fibers from the panels through the runways and into the sleeves.

At step 330, optical fibers from the OSP fibers and the ISP fibers are inserted into color-coded sleeves that correspond to the chosen color-coded panel.

At step 340, a corresponding color-coded runway is selected that aligns with the selected color-coded panel.

In some embodiments, the color-coded runways are configured to maintain a predetermined bend radius for the optical fibers contained within the color-coded sleeves.

In some embodiments, each of the plurality of color-coded panels includes a labeling area configured to display connectivity information corresponding to the plurality of optical fibers contained within the color-coded sleeves.

At step 350, the color-coded sleeves are routed through the corresponding color-coded runway to the color-coded panel.

In some embodiments, routing the optical fibers includes aligning the ports on the color-coded panels with the color-coded runways.

In some embodiments, installing the set of optical fibers further comprises securing the color-coded sleeves in the corresponding color-coded runway with a plurality of color-coded latches.

In some embodiments, installing the set of optical fibers further comprises organizing slack from the set of optical fibers in a built-in cable management system. The cable management system may be color-coded to correspond with the color-coded panels, runways, and sleeves.

In some embodiments, splices of the optical fibers are housed in a plurality of modular splice tray(s), wherein each tray is color-coded to match with corresponding panels and runways.

While the various steps in this flowchart are presented and described sequentially, at least some of the steps may be executed in different orders, may be combined or omitted, and some of the steps may be performed in parallel. Furthermore, the steps may be performed actively or passively.

The illustrative embodiments described herein provide an apparatus that is composed of several integrated components designed for fiber optic management. Multiple color-coded panels serve as an organizational interface. Each panel may be assigned a unique color that corresponds to a specific function or destination of the fiber optics.

A plurality of color-coded runways correspond to the color-coded panels. The colors on the runways align with those on the panels, creating a visually coordinated pathway system that guides the optical fibers to their designated locations. This color alignment provide a visual indication of a predetermined fiber route, minimizing the risk of misrouting or confusion during installation and maintenance.

Optical fibers from both OSP and ISP cables are broken out and threaded into several color-coded sleeves. These sleeves are protective conduits that encase the optical fibers. Like the panels and runways, the sleeves adhere to the color-coding system. Each sleeve's color matches the colors of the associated channels and panels, thereby continuing the visual coordination throughout the apparatus.

The term “about,” when used with respect to a physical property that may be measured, refers to an engineering tolerance expected by or determined by one ordinary skill in the art. The exact quantified degree of an engineering tolerance depends on the product being produced, the process being performed, or the technical property being measured. For a non-limiting example, two angles may be “about congruent” if the values of the two angles are within ten percent of each other. However, if the ordinary artisan determines that the engineering tolerance for a particular product should be tighter, then “about congruent” could be two angles having values that are within one percent of each other. Likewise, engineering tolerances could be loosened in other embodiments, such that “about congruent” angles have values within twenty percent of each other. In any case, the ordinary artisan is capable of assessing what is an acceptable engineering tolerance for a particular product, and thus is capable of assessing how to determine the variance of measurement contemplated by the term “about.”

As used herein, the term “connected to” contemplates at least two meanings. In a first meaning, unless otherwise stated, “connected to” means that component A could have been separate from component B, but is joined to component B in either a fixed or a removably attached arrangement. In a second meaning, unless otherwise stated, “connected to” means that component A is integrally formed with component B. Thus, for example, assume a bottom of a pan is “connected to” a wall of the pan. The term “connected to” may be interpreted as the bottom and the wall being separate components that are snapped together, welded, or are otherwise fixedly or removably attached to each other. Additionally, the term “connected to” also may be interpreted as the bottom and the wall being contiguously together as a monocoque body formed by, for example, a molding process.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, the term “or” is an “inclusive or” and, as such, includes the term “and.” Further, items joined by the term “or” may include any combination of the items with any number of each item, unless expressly stated otherwise.

In the above description, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description. Further, other embodiments not explicitly described above can be devised which do not depart from the scope of the invention as disclosed herein. Accordingly, the scope of the invention should be limited only by the attached claims.

What is claimed is:

1. An apparatus comprising:
a plurality of color-coded panels;
a plurality of color-coded runways corresponding to the plurality of color-coded panels;
a plurality of color-coded sleeves corresponding to the plurality of color-coded channels and comprising a plurality of optical fibers.

2. The apparatus of claim 1, further comprising:
a cabinet into which the rack, a plurality of color-coded panels, the plurality of color-coded runways, and the plurality of color-coded sleeves are installed.

3. The apparatus of claim 1, wherein each of the plurality of color-coded panels includes a labeling area configured to display connectivity information corresponding to the plurality of optical fibers contained within the color-coded sleeves.

4. The apparatus of claim 1, wherein the color-coded panels include ports that align with the color-coded runways to facilitate a structured routing of the optical fibers from the panels through the runways and into the sleeves.

5. The apparatus of claim 1, wherein the color-coded runways are configured to maintain a predetermined bend radius for the optical fibers contained within the color-coded sleeves.

6. The apparatus of claim 1, wherein the color-coded sleeves comprise a flexible, protective material.

7. The apparatus of claim 1, further comprising a plurality of modular splice tray(s), each tray color-coded to match with corresponding panels and runways for housing splices of the optical fibers.

8. The apparatus of claim 1, further comprising a management system for organizing slack from the optical fibers, the management system being color-coded to correspond with the color-coded panels, runways, and sleeves.

9. A method of installing optical fibers within a splice cabinet, the method comprising:
receiving a set of outside premises (OSP) fibers, and a set of inside premises (ISP) fibers at a splice cabinet;
selecting a color-coded panel from a plurality of color-coded panels within the splice cabinet based on the desired connectivity;
inserting optical fibers from the OSP fibers and the ISP fibers into color-coded sleeves that correspond to the chosen color-coded panel;
choosing a corresponding color-coded runway that aligns with the selected color-coded panel;
routing the color-coded sleeves through the corresponding color-coded runway to the color-coded panel.

10. The method of claim 9, wherein each of the plurality of color-coded panels includes a labeling area configured to display connectivity information corresponding to the plurality of optical fibers contained within the color-coded sleeves.

11. The method of claim 9, wherein the color-coded panels include ports that align with the color-coded runways to facilitate a structured routing of the optical fibers from the panels through the runways and into the sleeves.

12. The method of claim 9, wherein the step of selecting a color-coded panel includes referencing a labeling system that indicates the connectivity associated with each color-coded panel.

13. The method of claim 9, wherein the color-coded runways are configured to maintain a predetermined bend radius for the optical fibers contained within the color-coded sleeves.

14. The method of claim 9, wherein the step of routing the optical fibers includes aligning the ports on the color-coded panels with the color-coded runways.

15. The method of claim 9, wherein installing the set of optical fibers further comprises:
securing the color-coded sleeves in the corresponding color-coded runway with a plurality of color-coded latches.

16. The method of claim 9, wherein installing the set of optical fibers further comprises:
organizing slack from the set of optical fibers in a built-in cable management system.

17. The method of claim 16, wherein the cable management system is color-coded to correspond with the color-coded panels, runways, and sleeves.

18. The method of claim 9, further comprising:
housing splices of the optical fibers in a plurality of modular splice tray(s), wherein each tray is color-coded to match with corresponding panels and runways.

19. A splice cabinet comprising:
a plurality of color-coded panels;
a plurality of color-coded runways corresponding to the plurality of color-coded panels;
a plurality of color-coded sleeves corresponding to the plurality of color-coded channels and comprising a plurality of optical fibers; and
a cabinet into which the rack, a plurality of color-coded panels, the plurality of color-coded runways, and the plurality of color-coded sleeves are installed.
